(19) United States
(12) Patent Application Publication
(10) Pub. No.: US 2025/0370845 A1
(43) Pub. Date: Dec. 4, 2025

(54) METHODS FOR TROUBLESHOOTING SUBSTRATE DEFECTS USING MACHINE LEARNING

(71) Applicant: Applied Materials, Inc., Santa Clara, CA (US)

(72) Inventors: Glen Mori, Gilroy, CA (US); Yuanhong Guo, Mountain View, CA (US); Sachin Dangayach, San Jose, CA (US); Tianyuan Wu, San Jose, CA (US); Rahul Reddy Komatireddi, Hyderabad (IN); Rohith Cherikkallil, Kerala (IN)

(21) Appl. No.: 18/812,477

(22) Filed: Aug. 22, 2024

(30) Foreign Application Priority Data
May 30, 2024 (IN) 202441042044

(51) Int. Cl. G06F 11/07

(52) U.S. Cl. CPC G06F 11/079; G06F 11/0781

(57) ABSTRACT

A method includes receiving first information about one or more defects of a substrate processed using a process recipe. The method further includes processing the first information using a trained machine learning model that outputs matches to historical defects and score values for the matches. The method further includes receiving user input selecting a subset of the one or more matches. The method further includes updating the trained machine learning model based on the user input. The method further includes reprocessing the first information using the updated trained machine learning model that outputs one or more updated matches to historical defects and updated score values for the matches. The method further includes outputting an indication of one or more maintenance operations associated with the one or more updated matches to resolve one or more root causes associated with at least one of the one or more updated matches.

### RELATED APPLICATIONS

This application claims the benefit under 35 U.S.C. §119(a) of Indian Provisional Application No. 202441042044, filed May 30, 2024, the content of which is hereby incorporated by reference in its entirety.

### TECHNICAL FIELD

The present disclosure relates to methods associated with the troubleshooting of substrate defects processed in a substrate processing system. More particularly, the present disclosure relates to using machine learning to troubleshoot substrate defects.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Data may be collected for products (e.g., manufactured devices), which may enhance understanding of device function, failure, performance, may be used for metrology or inspection, or the like. Products may include defects that may be characterized based on images of the products.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes receiving, by a processing device, first data indicative of one or more defects of a substrate processed in a substrate processing system using a process recipe, the first data having a first data type. The method further includes processing, by the processing device, the first data using a first trained machine learning model that outputs first information about the one or more defects. The method further includes determining, by the processing device, one or more possible root causes for the one or more defects based at least in part on the first information. The method further includes outputting, by the processing device, a sequence of maintenance operations to be performed on the substrate processing system based on the one or more possible root causes for the one or more defects.

In another aspect of the present disclosure, a system includes a memory and a processing device coupled to the memory. The processing device is configured to receive first data indicative of one or more defects of a substrate processing in a substrate processing system using a process recipe, the first data having a first data type. The processing device is further configured to process the first data using a first trained machine learning model that outputs first information about the one or more defects. The processing device is further configured to determine one or more possible root causes for the one or more defects based at least in part on the first information. The processing device is further configured to output a sequence of maintenance operations to be performed on the substrate processing system based on the one or more possible root causes for the one or more defects.

In a further aspect of the present disclosure, a non-transitory machine-readable storage medium stores instructions which, when executed, cause a processing device to perform operations. The operations include receiving first data indicative of one or more defects of a substrate processed in a substrate processing system using a process recipe, the first data having a first data type. The operations further include processing the first data using a first trained machine learning model that outputs first information about the one or more defects. The operations further include determining one or more possible root causes for the one or more defects based at least in part on the first information. The operations further include outputting a sequence of maintenance operations to be performed on the substrate processing system based on the one or more possible root causes for the one or more defects.

In another aspect of the present disclosure, a method includes receiving, by a processing device, first information about one or more defects of a substrate processing in a substrate processing system using a process recipe. The method further includes processing, by the processing device, the first information using a trained machine learning model that outputs one or more matches to historical defects and score values for the matches, each of the historical defects having a historical root cause. One or more possible root causes of the one or more defects correspond to historical root causes associated with the matches to historical defects. The method further includes receiving, by the processing device, user input selecting a substrate of the one or more matches. The method further includes updating, by the processing device, the trained machine learning model based on the user input to produce an updated trained machine learning model. The method further includes reprocessing, by the processing device the first information using the updated trained machine learning model that outputs one or more updated matches to historical defects and updated score values for the matches. The method further includes outputting, by the processing device, an indication of one or more maintenance operations associated with the one or more updated matches to resolve one or more root causes associated with at least one of the one or more updated matches.

In another aspect of the present disclosure, a system includes a memory and a processing device coupled to the memory. The processing device is configured to receive first information about one or more defects of a substrate processing in a substrate processing system using a process recipe. The processing device is further configured to process the first information using a trained machine learning model that outputs one or more matches to historical defects and score values for the matches, each of the historical defects having a historical root cause. One or more possible root causes of the one or more defects correspond to historical root causes associated with the matches to historical defects. The processing device is further configured to receive user input selecting a subset of the one or more matches. The processing device is further configured to update the trained machine learning model based on the user input to produce an updated trained machine learning model. The processing device is further configured to reprocess the first information using the updated trained machine learning model that outputs one or more updated matches to historical defects and updated score values for the matches. The processing device is further configured to output an indication of one or more maintenance operations associated with the one or more updated matches to resolve one or more root causes associated with at least one of the one or more updated matches.

In a further aspect of the present disclosure, a non-transitory machine-readable storage medium stores instructions which, when executed, cause a processing device to perform operations. The operations include receiving first information about one or more defects of a substrate processing in a substrate processing system using a process recipe. The operations further include processing the first information using a trained machine learning model that outputs one or more matches to historical defects and score values for the matches, each of the historical defects having a historical root case. One or more possible root causes of the one or more defects correspond to historical root causes associated with the matches to historical defects. The operations further include receiving user input selecting a subset of the one or more matches. The operations further include updating the trained machine learning model based on the user input to produce an updated trained machine learning model. The operations further include reprocessing the first information using the updated trained machine learning model that outputs one or more updated matches to historical defects and updated score values for the matches. The operations further include outputting an indication of one or more maintenance operations associated with the one or more updated matches to resolve one or more root causes associated with at least one of the one or more updated matches.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2A depicts a block diagram of a system including an example data set generator for creating data sets for one or more supervised models, according to some embodiments.

FIG. 2B depicts a block diagram of an example data set generator for creating data sets for a supervised model configured to generate an indication of predicted defect properties of a substrate, according to some embodiments.

FIG. 3 is a block diagram illustrating a system for generating output data, according to some embodiments.

FIG. 4A is a flow diagram of a method for determining a possible root cause of a substrate defect, according to some embodiments.

FIG. 4B is a flow diagram of a method for determining a possible root cause of a substrate defect, according to some embodiments.

FIG. 5A-C are block diagrams of flows for determining a possible root cause of a substrate defect, according to some embodiments.

FIG. 6 is a block diagram illustrating a computer system, according to some embodiments.

### DETAILED DESCRIPTION

Described herein are technologies related to troubleshooting substrate defects using machine learning. Manufacturing equipment is used to produce products, such as patterned substrates (e.g., wafers, semiconductors). Manufacturing equipment may include a manufacturing or processing chamber to separate the substrate from an external environment. The properties of produced substrates are to meet target values to facilitate specific functionalities. Manufacturing parameters are selected to produce substrates that meet the target property values. Target property values may include target defect parameters, such as a target maximum number of defects, target maximum defect density, target count of density of two or more types of defects, etc. Many manufacturing parameters (e.g., hardware parameters, process parameters, etc.) contribute to the properties of processed substrates. Additionally, the age of process chambers and/or chamber components, the types of processes performed by the process chambers, the buildup of material on surfaces of the process chambers, part degradation and/or failure, and many other variables may affect a type and/or number of defects that occur on processed substrates. Detected defects may be caused by aspects or features of manufacturing equipment, by aspects or features of process recipes executed on the manufacturing equipment, or a combination thereof. In some embodiments, trained machine learning models are utilized to improve performance of manufacturing equipment and/or process recipes and/or improve performance of the manufactured substrates by assisting in performing root cause analysis for defects.

Classifying, counting, and determining the location of defects caused by a substrate manufacturing process using manufacturing equipment (e.g., a process chamber), and determining the root cause of such defects, enables improvement to the manufacturing process, improvements to the manufacturing equipment, improvements to substrate design, etc. Additionally, by facilitating determination of root causes for defects, and providing troubleshooting guides associated with the determined root causes, embodiments speed up the process of identifying and addressing defect root causes. By classifying, counting, and/or determining the locations of defects, the root cause of the defect may be determined, corrective actions may be determined, and the corrective actions may be performed to correct the defects or to prevent similar defects from future processed substrates. However, conventional approaches for troubleshooting defects to determine root causes and/or to determine corrective actions can be tedious and/or lengthy. In some cases, a processing system engineer (e.g., an operator, a user, etc.) evaluates the defects to determine a root cause. The engineer may rely on experience and vast amounts of data to determine the root cause of the defect. The engineer can then refer to a troubleshooting decision tree to determine operations (e.g., maintenance operations, corrective operations, etc.) that can be performed to the processing system to resolve the root cause.

However, engineers can make mistakes in their evaluation and/or rely on judgments or experience that is not sound and/or not without fault. Specifically, engineers sometimes fail to identify and/or interpret a substrate defect correctly. Moreover, the process of evaluating the defect, by the engineer, and referencing the troubleshooting decision tree can be a tedious process. Often, this process can be time-consuming to perform and implement. Further, errors can be introduced because of human factors, leading to inaccuracies in evaluating the defects, determining root causes, and/or determining corrective actions. Thus, human factors can introduce repeatability errors into the process of troubleshooting substrate defects. A method of automating the evaluation of defects, determination of root causes, and/or determination of corrective actions may increase the accuracy of the troubleshooting process.

In some embodiments described herein, a framework for automated defect analysis is provided using various data types associated with substrates and substrate defects. In some embodiments, methods are provided for troubleshooting substrate defects using one or more machine learning models. Defects may be compared with visually similar defects to determine a root cause of the defects and operations that can be performed on a substrate processing system to correct for the defects.

In some embodiments, data is received that is indicative of one or more defects of a substrate processed in a substrate processing system using a process recipe. In some embodiments, the data can include image data, such as an image of the substrate and/or of the substrate defects. In some embodiments, the data includes textual data, spectral data, map data, and/or image data. In some embodiments, the data is processed using a trained machine learning model. The trained machine learning model may output information about the one or more defects such as possible root causes, corrective action(s), and/or matching score values, etc. In some embodiments, multiple trained machine learning models are used to determine information about the one or more defects. For example, and in some embodiments, one or more first trained machine learning models may process a first subset of the data and may output intermediate data, such as textual data, associated with the substrate defects. The intermediate data may include data such as defect type, defect pattern, defect composition, matching defect images (from historical data), etc. The intermediate data (e.g., the textual data) and/or a second subset of the data (indicative of the substrate defects) may be provided to a second trained machine learning model that outputs the information about the one or more defects.

In some embodiments, the information about the one or more defects output by the trained machine learning model may include one or more matches to historical defects. For example, the machine learning model may output identifiers for one or more historical defects that are similar to a current defect. In some embodiments, information about the matching historical defects may be retrieved from a data store based on the output identifiers. The information may include data (e.g., image data, etc.) of prior substrate defects that may at least partially match the substrate defects. The information may be retrieved from a data store (e.g., a database, a data structure, etc.) that stores information about historical defects, such as image data, root cause data, corrective action data, etc. Score values may be assigned to individual matches that indicate how closely the matches to historical defects match the substrate defects. In some embodiments, the matches to historical defects are presented on a graphical user interface (GUI) for a user (e.g., a process engineer, a technician, etc.) to view. In some embodiments, user input is received (e.g., via the GUI), selecting a subset of the matches. The selected subset of the matches may be selected (e.g., by the user) that most closely corresponds to (e.g., matches) the one or more substrate defects. In some embodiments, the user input is provided to the trained machine learning model as training input to update the trained machine learning model. Moreover, the user input may be used to update the score values provided by the trained machine learning model.

In some embodiments, the updated trained machine learning model reprocesses the data indicative of the substrate defects and outputs updated matches to historical defects and updated score values associated with the updated matches. In some embodiments, each of the historical matches is associated with a historical root cause. Information associated with each of the historical root causes may be stored in the data store described herein. In some embodiments, a possible root cause for the substrate defect is determined based on the historical root cause information. A match to a historical defect having greater than a threshold score value may be determined to be the closest historical match (e.g., a possible historical match, etc.). A root cause associated with the closest historical match may be identified and retrieved (e.g., from the data store). The identified root cause may be a possible root cause for the substrate defect. Once the possible root cause is determined, one or more maintenance operations (e.g., corrective actions) can be identified to resolve the one or more root causes associated with the substrate defects.

In some embodiments, a sequence of maintenance operations is associated with each of the matches to historical defects and/or corresponding root causes. The sequences of maintenance operations may be part of a superset of maintenance operations for the substrate processing system. Each of the sequences may be stored in the data store. In some embodiments, based on the identified possible root cause for the substrate defect, an indication of the corresponding sequence of maintenance operations is output (e.g., for display on the GUI). In some embodiments, the sequence of maintenance operations can be performed (e.g., by the engineer, by the technician, by the user, etc.) to confirm and/or resolve the determined possible root cause for the substrate defect.

Embodiments of the present disclosure provide advantages over conventional solutions. By using at least one trained machine learning model, the process of troubleshooting substrate defects can be performed faster and with fewer errors than using previous methods. For example, the computer and machine learning algorithms described herein can identify a sequence of maintenance operations that can be performed to resolve a substrate defect root cause faster and more accurately than conventional methods that rely on human judgment and experience. Moreover, by increasing the speed at which substrate defects are troubleshooted, the substrate processing system can be more quickly adjusted to minimize the number of substrate defects. Therefore, more substrates can be processed that meet process recipe specifications and with fewer defects. Accordingly, overall system throughput can be increased with increased processed substate accuracy.

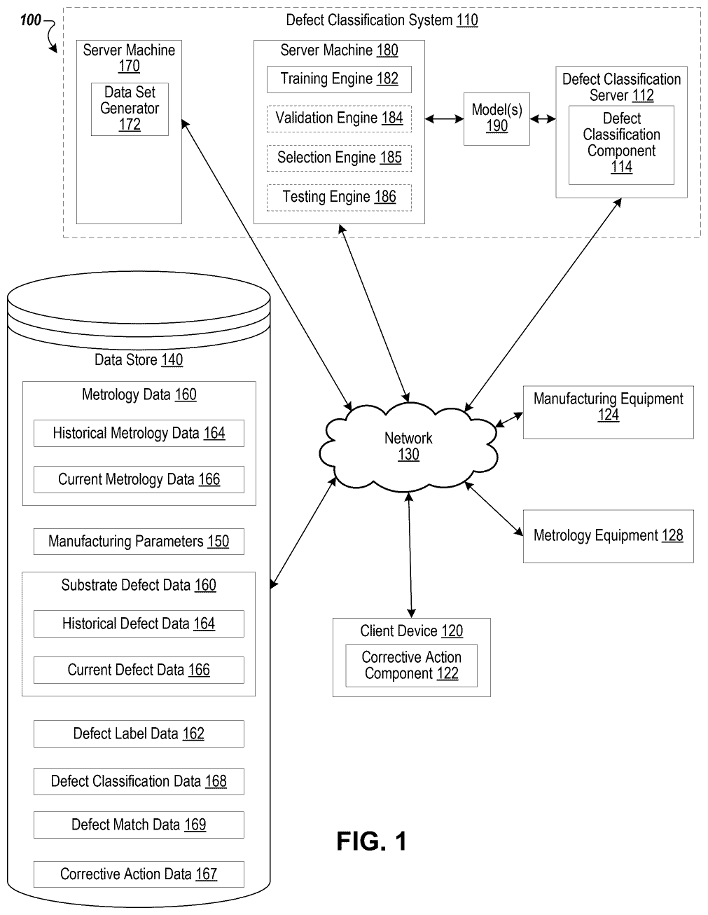

FIG. 1 is a block diagram illustrating an exemplary system 100 (exemplary system architecture), according to some embodiments. The system 100 includes a client device 120, manufacturing equipment 124, metrology equipment 128, defect classification server 112, and data store 140. The defect classification server 112 may be part of defect classification system 110. Defect classification system 110 may further include server machines 170 and 180.

Substrates may have property values (film thickness, film strain, etc.) measured by metrology equipment 128, e.g., measured at a standalone metrology facility. Metrology data 160 may be a component of data store 140. Metrology data 160 may include historical metrology data 164 (e.g., metrology data associated with previously processed products). Metrology data 160 may include current metrology data 166 (e.g., measurement data of one or more target substrates, one or more substrates of interest, or the like). In some embodiments, current metrology data 166 may be provided to one or more processing devices for performance of defect determination, classification, and/or root cause analysis. In some embodiments, current metrology data 166 may be provided to one or more trained machine learning models for possible root cause determination. In some embodiments, metrology data 160 may include scanning electron microscope (SEM) image data, energy dispersive X-ray (EDX) image data, other image data, and/or geometric data (e.g., such as defect size data, etc.).

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed).

Metrology equipment 128 may include imaging instruments, e.g., for performing substrate imaging techniques. Metrology data 160 may include image data generated by imaging instruments of metrology equipment 128. Imaging techniques performed by metrology equipment 128 may include one or more optical microscopes, scanning electron microscopes, transmission electron microscopes, or the like.

In some embodiments, metrology data 160, and/or manufacturing parameters 150 may be processed (e.g., by the client device 120 and/or by the defect classification server 112). Processing of the metrology data 160 may include generating and/or detecting features. In some embodiments, the features are a pattern in the metrology data 160, and/or manufacturing parameters 150 (e.g., slope, width, height, peak, etc.) or a combination of values from the metrology data 160, and/or manufacturing parameters 150 (e.g., power derived from voltage and current, etc.). In some embodiments, features are shapes or relationships between portions of image data, for example defect patterns, etc. Manufacturing parameters 150, and/or metrology data 160 may include features and the features may be used by defect classification component 114 for performing signal processing and/or for obtaining defect classification data 168 for performance of a corrective action, for determining of troubleshooting operations to perform, and so on.

Each instance (e.g., set) of metrology data 160 may correspond to a product (e.g., a substrate), a set of manufacturing equipment, a type of substrate produced by manufacturing equipment, or the like. Each instance of manufacturing parameters 150 may likewise correspond to a product, a set of manufacturing equipment, a type of substrate produced by manufacturing equipment, or the like. The data store may further store information associating sets of different data types, e.g., information indicative that a set of sensor data, a set of metrology data, and a set of manufacturing parameters are all associated with the same product, manufacturing equipment, type of substrate, etc.

Defect classification system 110 may be utilized to generate defect classification data 168. Different defect classification data 168 may be determined for different types of input metrology data and/or other input data related to defects (e.g., engineer observations). Some defect classification data 168 may be generated by performing image processing operations and/or machine learning operations on image data of one or more substrates. Some defect classification data 168 may be generated by performing spectral analysis operations and/or machine learning operations on EDX data of one or more substrates. Defect classification data 168 may be data indicative of one or more defects of a substrate. Defect classification data 168 may be indicative of classification, count, locations, density, severity, etc., of defects of one or more substrates. Defect classification data 168 may be generated by performing feature detection operations on image data associated with one or more substrates (e.g., using one or more trained machine learning models). Operations for determining defect data of substrates may be performed by defect classification server 112, defect classification component 114, etc.

Defect classification system 110 may be utilized to generate defect match data 169. Different defect match data 169 may be determined for different types of input metrology data and/or other input data related to defects (e.g., engineer observations). Some defect match data 169 may be generated by performing data processing operations and/or machine learning operations on defect classification data 168. Defect match data 169 may be indicative of one or more matches to historical defects of a current substrate defect. Operations for determining defect match data 169 may be performed by the defect classification server 112, defect classification component 114, etc.

In some embodiments, defect classification system 110 may be utilized to generate defect classification data 168 and/or defect match data 169 using one or more trained machine learning models. In some embodiments, defect classification system 110 may generate defect classification data 168 and/or defect match data 169 using supervised machine learning. Supervised machine learning refers to operations associated with a machine learning model that was provided with labeled training data, such as image data labeled by counts of defects. In some embodiments, defect classification system 110 may generate defect classification data 168 and/or defect match data 169 using unsupervised machine learning. Unsupervised machine learning refers to operations associated with a machine learning model that was trained using unlabeled input. Unsupervised machine learning operations may include clustering results, principle component analysis, anomaly detection, etc. In some embodiments, defect classification system 110 may generate defect classification data 168 and/or defect match data 169 using semi-supervised learning (e.g., training data may include a mix of labeled and unlabeled data, etc.).

Client device 120, manufacturing equipment 124, metrology equipment 128, defect classification server 112, data store 140, server machine 170, and server machine 180 may be coupled to each other via network 130 for generating defect classification data 168 and/or defect match data 169 to perform corrective actions. In some embodiments, network 130 may provide access to cloud-based services. Operations performed by client device 120, defect classification system 110, data store 140, etc., may be performed by virtual cloud-based devices.

In some embodiments, network 130 is a public network that provides client device 120 with access to the defect classification server 112, data store 140, and other publicly available computing devices. In some embodiments, network 130 is a private network that provides client device 120 access to manufacturing equipment 124, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the defect classification system 110, receives output (e.g., defect classification data 168) from the defect classification system 110, determines a corrective action based on the output, and causes the corrective action to be implemented. In some embodiments, corrective action component 122 obtains metrology data 160 and provides metrology data 160 to defect classification system 110.

In some embodiments, corrective action component 122 may retrieve current metrology data 166 (e.g., one or more images of a substrate of interest, one or more maps of a substrate of interest, etc., possibly including indications of defects). Corrective action component 122 may provide the current metrology data 166 to defect classification system 110 for determining the presence, arrangement, and/or identification of defects of the substrate. Defect classification system 110 may utilize image processing, feature detection operations, image filtering, frequency domain transformations, and/or other techniques for making determinations in association with the metrology data and defects.

Defect classification system 110 may provide one or more images or maps of a substrate to one or more trained machine learning models (e.g., model(s) 190) for making determinations in association with defects of the substrate. In some embodiments, different ML models are trained to determine defect classification information for different types of input data. For example, a first trained machine learning model may be trained to determine a pattern of one or more substrate defects based on input substrate image data. In another example, a second trained machine learning model may be trained to determine a composition of one or more substrate defects based on input substrate spectral data (e.g., EDX data, etc.). In a further example, a third trained machine learning model may be trained to determine a matching image of a historical substrate (e.g., a historical substrate defect, etc.) based on input substrate image data. In some embodiments, model(s) 190 may represent one or more physics-based, image processing algorithms, and/or machine learning models. In some embodiments, model(s) 190 may instead or additionally be configured to make predictions (e.g., generate defect classification data 168) indicative of portions of the substrate that were not imaged. For example, model(s) 190 may be configured to predict properties (e.g., defect locations and/or classifications) in portions of the substrate that were not imaged, based on image data of portions of the substrate that were imaged.

In some embodiments, corrective action data 167 may include an indication of a corrective action to be performed. Defect classification system 110 may be utilized to generate and/or to determine corrective action data 167. Different corrective action data 167 may be determined for different types of input metrology data and/or other input data related to defects (e.g., engineer observations). Corrective action data 167 be indicative of a superset of maintenance operations that can be performed with respect to a substrate processing system for correction of substrate defects. Corrective action data 167 may include subsets of maintenance operations for different defect classifications and/or defect matches indicated in defect classification data 168 and/or defect match data 169.

In some embodiments, corrective action component 122 receives an indication of a corrective action (e.g., indicated in corrective action data 167) and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

Historical metrology data 164 may correspond to products processed using manufacturing parameters and/or recipes associated with historical sensor data and historical manufacturing parameters. Historical metrology data 164 may correspond to metrology data generated for substrates that experienced one or more historical defects. Such historical metrology data 164 may be associated with historical use cases, which may have been resolved and may indicate the root causes of those historical defects. Defect classification data 168 for the historical defects may include analysis performed on historical metrology data to generate additional insight into root causes of the historical defects.

In some embodiments, defect match data 169 includes one or more matches to historical substrate defects. Defect match data 169 may include a characterization of the substrate defect as being similar to the one or more historical substrate defects. Defect match data 169 may further include root cause data and/or corrective action data associated with the one or more historical substrate defects.

Performing manufacturing processes that result in defective products can be costly in time, energy, products, components, manufacturing equipment 124, the cost of identifying the defects and discarding the defective product, additional environmental impact incurred by the manufacturing, characterization, and/or disposal processes, etc. By inputting current metrology data 166 indicative of defects into defect classification system 110, receiving output of defect classification data 168 and/or defect match data 169, determining matches to historical defects and corrective actions and/or underlying root causes associated with those historical defects, and performing the corrective actions, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting current metrology data 166 into defect classification system 110, receiving output of defect classification data 168, and performing corrective action (e.g., predicted operational maintenance, such as replacement, processing, cleaning, etc. of components) based on the defect classification data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, metrology equipment 128, and the like, may provide indications of degrading, drifting, and/or aging components.

Manufacturing parameters may be suboptimal for producing products which may have costly results of increased resource (e.g., energy, coolant, gases, etc.) consumption, increased amount of time to produce the products, increased component failure, increased amounts of defective products, increased environmental impact, etc. By inputting indications of metrology into defect classification system 110, receiving output of defect classification data 168 and/or defect match data 169, and performing a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like. Corrective actions may include one or more steps in maintenance operations and/or troubleshooting operations that may be performed (e.g., by a technician) to confirm a root cause for a detected defect.

In some embodiments, the corrective action includes providing an alert. In some embodiments, the corrective action includes providing a sequence of maintenance operations that can be performed with respect to manufacturing equipment 124. In some embodiments, the corrective action includes providing feedback control (e.g., modifying a manufacturing parameter based on the defect classification data 168 and/or defect match data 169). In some embodiments, performance of the corrective action includes causing updates to one or more manufacturing parameters. In some embodiments, performance of the corrective action may include scheduling and/or performing one or more maintenance operations, including component cleaning or replacement, chamber cleaning, chamber seasoning, etc.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Defect classification server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of defect classification server 112, server machine 170, server machine 180, data store 140, etc., may be performed by a cloud computing service, cloud data storage service, etc.

Defect classification server 112 may include a defect classification component 114. In some embodiments, the defect classification component 114 may receive current metrology data 166 and generate output (e.g., defect classification data 168) that provides information about a current defect (e.g., defect classification data 168). In some embodiments, defect classification data 168 may include a count, classification, density, and/or location map of defects represented in image data of a substrate, predicted properties of defects based on image data of the substrate, etc. In some embodiments, the defect classification component may further process the determined information about the current defect (e.g., defect classification data 168) to determine matches to one or more historical defects. The matches to one or more historic defects may be indicated in defect match data 169. Based on the matches to historical defects (e.g., defect match data 169, etc.), defect classification component 114 may determine one or more potential root causes for the defect and/or one or more sequences of operations to be performed to troubleshoot the defect and confirm and/or address the root cause. Receiving current metrology data 166 may include obtaining the data from client device 120. Receiving current metrology data 166 may include retrieving the data from data store 140.

In some embodiments, defect classification component 114 may determine information about defects represented in image data (e.g., metrology data 160) based on image processing operations. For example, defect classification component 114 may receive substrate image data. Defect classification component 114 may perform pre-processing to improve usability of the image, such as gaussian blur operations, sharpening operations, etc. Defect classification component 114 may perform transform operations (e.g., Fourier transform operations) to transform the image data from a spatial domain to a frequency domain. Defect classification component 114 may apply filtering to the frequency domain image data. The filters may be designed to accentuate, highlight, or the like one or more target defects. In some embodiments, an image of a substrate may have several filters applied, to generate a number of filtered image data for determining different types of defects. Defect classification component 114 may perform additional image processing techniques, such as transforming the image data back to a spatial domain, performing image thresholding, etc. Image thresholding may include increasing contrast of an image, e.g., to improve feature detection, defect detection, defect classification, etc. Image thresholding may include adjusting each pixel with brightness above a threshold value to maximum brightness (e.g., to a brightness of 1) and adjusting each pixel with brightness below the threshold value to a minimum brightness (e.g., to a brightness of 0). Defect classification component 114 may perform feature detection operations such as contour detection, circle detection, or the like, to determine presence evidence of defects in the image data.

In some embodiments, one or more operations of defect determination may be tuned to adjust/improve performance of the defect determination. In some embodiments, defect label data 162 may be provided for adjusting parameters of the defect determination. Defect label data 162 may include information indicative of defects of one or more substrates, one or more images, or the like, generated by a different method than the method the defect label data 162 is being used to tune. For example, defect label data 162 may be provided by a subject matter expert manually determining characteristics of defects of a substrate. The defect label data 162 may be utilized in tuning parameters of a defect determination system to improve performance of the defect determination system. Example parameters that may be adjusted include image pre-processing parameters, such as gaussian blur standard deviation, image filtering parameters, such as frequency domain filter shapes, image thresholding parameters, such as adjustment thresholds, and adjustment values, feature thresholds at which detected features are included in defect classification, etc.

Manufacturing equipment 124 may be associated with one or more machine leaning models, e.g., model(s) 190. Machine learning models associated with manufacturing equipment 124 may perform many tasks, including process control, classification, performance predictions, etc. Model(s) 190 may be trained using data associated with manufacturing equipment 124 or products processed by manufacturing equipment 124, manufacturing parameters 150 (e.g., associated with process control of manufacturing equipment 124), metrology data 160 (e.g., generated by metrology equipment 128), etc.

In some embodiments, defect classification system 110 may include a machine learning model that outputs matches to historic substrate defects. For example, imaging techniques may be performed that generate images of at least a subset of a surface of the substrate. A machine learning model (e.g., executed by defect classification component 114) may be utilized to determine a historic match to a substrate defect depicted in the images. In some embodiments, defect classification system 110 includes a trained machine learning model that receives defect classification data 168, which may include data generated by other ML models based on processing of various types of metrology data and/or observations of a technician or engineer. The trained machine learning model may determine matches to one or more historical defects (e.g., indicated in defect match data 169), each of which may be associated with one or more root causes and/or one or more sequences of operations to be performed to confirm and/or correct the one or more root causes. In some embodiments, the trained ML model outputs probability values or scores for matches to one or more historical defects. Processing logic may then perform lookups in a data store for information about the matching historical defects, such as root causes, images, historical metrology data, sequences of operations to perform, and so on.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). CNNs have found particular applicability in the area of image processing, e.g., processing substrate image data for epitaxial defect determination.

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, defect classification component 114 receives current sensor data, current metrology data 166 and/or current manufacturing parameters, performs signal processing to break down the current data into sets of current data, provides the sets of current data as input to a trained model(s) 190, and obtains outputs indicative of defect classification data 168 from the trained model(s) 190. In some embodiments, defect classification component 114 receives metrology data (e.g., predicted metrology data based on sensor data) of a substrate and provides the metrology data to trained model(s) 190. For example, current sensor data may include sensor data indicative of metrology (e.g., geometry) of a substrate. Model(s) 190 may be configured to accept data indicative of substrate metrology and generate as output classifications or properties of defects of the substrate.

In some embodiments, the various models discussed in connection with model(s) 190 (e.g., supervised machine learning model, unsupervised machine learning model, etc.) may be combined in one model (e.g., an ensemble model), or may be separate models.

Data may be passed back and forth between several distinct models included in model(s) 190 and defect classification component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store manufacturing parameters 150, metrology data 160, synthetic data 162, and defect classification data 168.

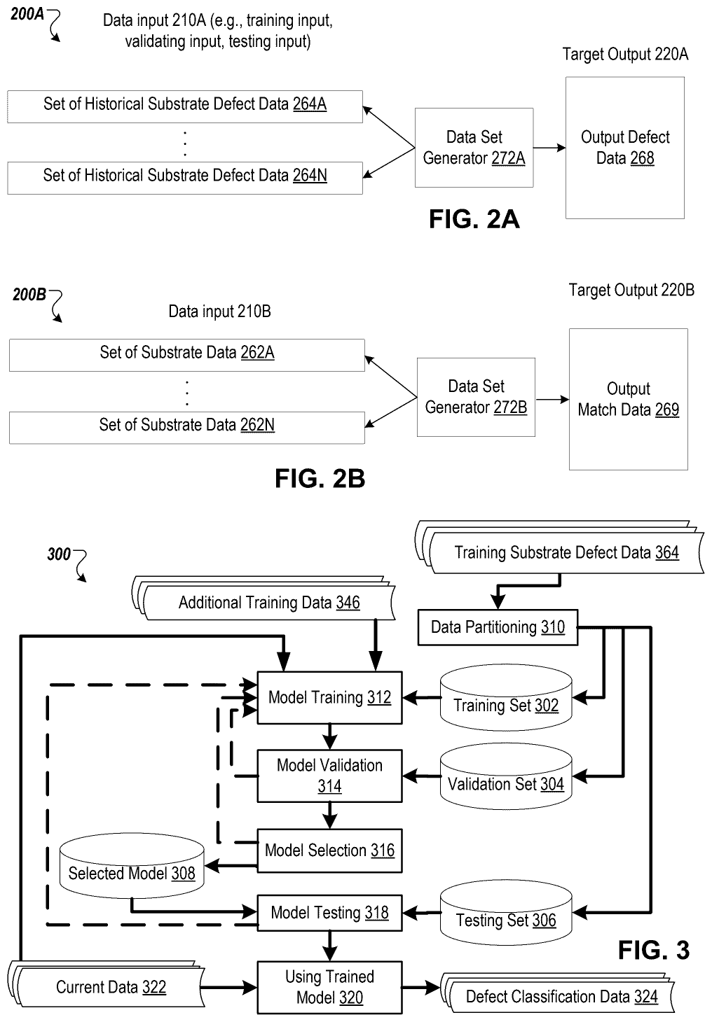

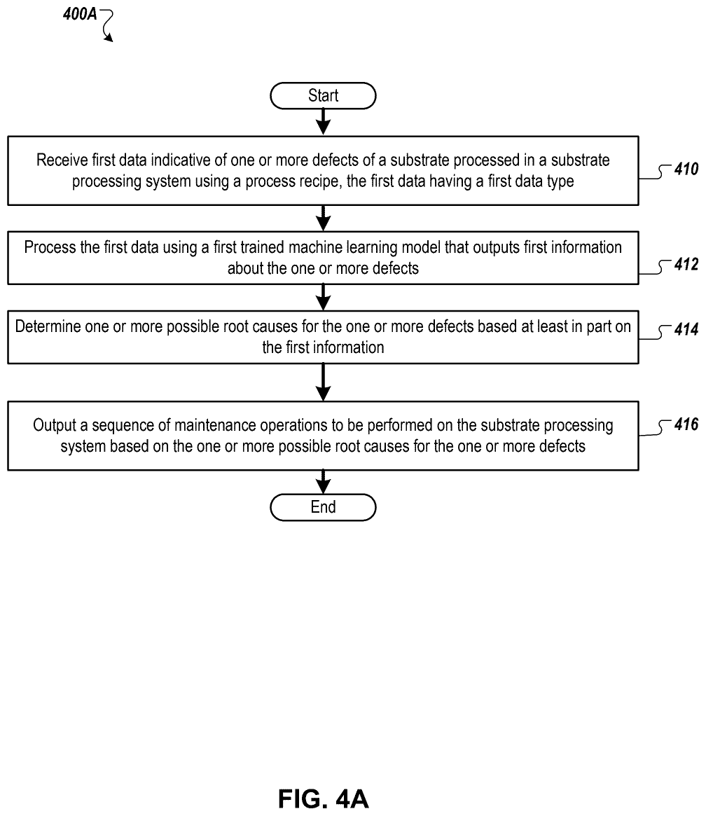

In some embodiments, defect classification system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2A-B and 4A. In some embodiments, data set generator 172 may partition the historical data (e.g., historical metrology data 164) into a training set (e.g., sixty percent of the historical data), a validating set (e.g., twenty percent of the historical data), and a testing set (e.g., twenty percent of the historical data).

In some embodiments, defect classification system 110 (e.g., via defect classification component 114) generates multiple sets of features. For example a first set of features may correspond to a first set of types of metrology data (e.g., from a first set of metrology equipment, first type of substrate imaging technique, etc.) that correspond to each of the data sets (e.g., training set, validation set, and testing set) and a second set of features may correspond to a second set of types of metrology data (e.g., from a second type of metrology device) that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model(s) 190 using one or more sets of features associated with the training set from data set generator 172. The training engine 182 may generate multiple trained models 190, where each trained model(s) 190 corresponds to a distinct set of features of the training set (e.g., metrology data from distinct metrology devices). Data set generator 172 may receive the output of a trained model, collect that data into training, validation, and testing data sets, and use the data sets to train a second model (e.g., a machine learning model configured to output predictive data, corrective actions, etc.).

Validation engine 184 may be capable of validating a trained model(s) 190 using a corresponding set of features of the validation set from data set generator 172. For example, a first trained machine learning model(s) 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model(s) 190 that has the highest accuracy of the trained models 190.

Testing engine 186 may be capable of testing a trained model(s) 190 using a corresponding set of features of a testing set from data set generator 172. For example, a first trained machine learning model(s) 190 that was trained using a first set of features of the training set may be tested using the first set of features of the testing set. Testing engine 186 may determine a trained model(s) 190 that has the highest accuracy of all of the trained models based on the testing sets.

In the case of a machine learning model, model(s) 190 may refer to the model artifact that is created by training engine 182 using a training set that includes data inputs and corresponding target outputs (correct answers for respective training inputs. Patterns in the data sets can be found that map the data input to the target output (the correct answer), and machine learning model(s) 190 is provided mappings that capture these patterns. The machine learning model(s) 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Defect classification component 114 may provide current data to model(s) 190 and may run model(s) 190 on the input to obtain one or more outputs. For example, defect classification component 114 may provide current metrology data 166 to model(s) 190 and may run model(s) 190 on the input to obtain one or more outputs. Defect classification component 114 may be capable of determining (e.g., extracting) defect classification data 168 from the output of model(s) 190. Defect classification component 114 may determine (e.g., extract) confidence data from the output that indicates a level of confidence that defect classification data 168 is an accurate predictor of a defect classification for a substrate produced using the manufacturing equipment 124 at the current metrology data 166 and/or current manufacturing parameters. Defect classification component 114 or corrective action component 122 may use the confidence data to decide whether to cause a corrective action associated with the manufacturing equipment 124 based on defect classification data 168.

The confidence data may include or indicate a level of confidence that the defect classification data 168 is an accurate prediction for products or components associated with at least a portion of the input data. In one example, the level of confidence is a real number between 0 and 1 inclusive, where 0 indicates no confidence that the defect classification data 168 is an accurate prediction for products processed according to input data or component health of components of manufacturing equipment 124 and 1 indicates absolute confidence that the defect classification data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) defect classification component 114 may cause trained model(s) 190 to be re-trained (e.g., based on current sensor data 146, current manufacturing parameters, etc.). In some embodiments, retraining may include generating one or more data sets (e.g., via data set generator 172) utilizing historical data.

For purpose of illustration, rather than limitation, aspects of the disclosure describe the training of one or more machine learning models 190 using historical data (e.g., historical sensor data, historical manufacturing parameters) and inputting current data (e.g., current sensor data, current manufacturing parameters, and current metrology data) into the one or more trained machine learning models to determine defect classification data 168. In other embodiments, a heuristic model, physics-based model, or rule-based model is used to determine defect classification data 168 (e.g., without using a trained machine learning model) and/or defect match data 169. In some embodiments, such models may be trained using historical data. Defect classification component 114 may monitor historical sensor data 144, historical manufacturing parameters, and metrology data 160. Any of the information described with respect to data inputs 210A-B of FIGS. 2A-B may be monitored or otherwise used in the heuristic, physics-based, or rule-based model.

In some embodiments, the functions of client device 120, defect classification server 112, server machine 170, and server machine 180 may be provided by a fewer number of machines. For example, in some embodiments server machines 170 and 180 may be integrated into a single machine, while in some other embodiments, server machine 170, server machine 180, and defect classification server 112 may be integrated into a single machine. In some embodiments, client device 120 and defect classification server 112 may be integrated into a single machine. In some embodiments, functions of client device 120, defect classification server 112, server machine 170, server machine 180, and data store 140 may be performed by a cloud-based service.

In general, functions described in one embodiment as being performed by client device 120, defect classification server 112, server machine 170, and server machine 180 can also be performed on defect classification server 112 in other embodiments, if appropriate. In addition, the functionality attributed to a particular component can be performed by different or multiple components operating together. For example, in some embodiments, the defect classification server 112 may determine the corrective action based on the defect classification data 168. In another example, client device 120 may determine the defect classification data 168 based on output from the trained machine learning model.

In addition, the functions of a particular component can be performed by different or multiple components operating together. One or more of the defect classification server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIGS. 2A-B depict block diagrams of example data set generators 272A-B (e.g., data set generator 172 of FIG. 1) to create data sets for training, testing, validating, etc. a model (e.g., model(s) 190 of FIG. 1), according to some embodiments. Each data set generator 272 may be part of server machine 170 of FIG. 1. In some embodiments, several machine learning models associated with manufacturing equipment 124 may be trained, used, and maintained (e.g., within a manufacturing facility). Each model may be associated with one data set generators 272, multiple models may share a data set generator 272, etc.

FIG. 2A depicts a system 200A including data set generator 272A for creating data sets for one or more supervised models (e.g., model(s) 190 of FIG. 1). Data set generator 272A may create data sets (e.g., data input 210A, target output 220A) using historical data. In some embodiments, a data set generator similar to data set generator 272A may be utilized to train an unsupervised machine learning model, e.g., target output 220A may not be generated by data set generator 272A.

Data set generator 272A may generate data sets to train, test, and validate a model. In some embodiments, data set generator 272A may generate data sets for one or more machine learning models. In some embodiments, data set generator 272A may generate data sets for training, testing, and/or validating a model configured to output information about defects of a substrate. The machine learning model is provided with set of historical metrology data 264A as data input 210A. The machine learning model may be configured to accept metrology data as input data and output information about defects as output.

Data set generator 272A may be used to generate data for any type of machine learning model that takes as input metrology data. Data set generator 272A may be used to generate data for a machine learning model that generates information about defects of a substrate. Data set generator 272A may be used to generate data for a machine learning model configured to provide historical defect matching. Data set generator 272A may be used to generate data for a machine learning model configured to identify and/or classify a product anomaly and/or processing equipment fault. Data set generator 272A may be used to generate data for a machine learning model configured to output information about defects of a substrate.

In some embodiments, data set generator 272A generates a data set (e.g., training set, validating set, testing set) that includes one or more data inputs 210A (e.g., training input, validating input, testing input). Data inputs 210A may be provided to training engine 182, validating engine 184, or testing engine 186. The data set may be used to train, validate, or test the model.

In some embodiments, data input 210A may include one or more sets of data. As an example, system 200A may produce sets of data that may include one or more of metrology data from one or more types of metrology equipment, combinations of data from one or more types of metrology equipment, metrology data from one or more locations of associated substrates, patterns from metrology data from one or more types of imaging, etc.

In some embodiments, data input 210A may include one or more sets of data. As an example, system 200A may produce sets of historical metrology data that may include one or more of metrology data of a group of dimensions of a device (e.g., include height and width of the device but not optical data or surface roughness, etc.), patterns from metrology data, metrology data preprocessed in different ways, metrology data generated by different equipment and/or techniques, etc. Sets of data input 210A may include data describing different aspects of manufacturing, e.g., a combination of metrology data, a combination of metrology data and manufacturing parameters, combinations of some metrology data, some manufacturing parameter data and some sensor data, etc.

In some embodiments, data set generator 272A may generate a first data input corresponding to a first set of historical metrology data 264A to train, validate, or test one or more first machine learning models. Data set generator 272A may generate a second data input corresponding to a second set of historical metrology data (e.g., a set of historical metrology data 264B, not shown) to train, validate, or test one or more second machine learning models. Further sets of historical metrology data may further be utilized in generating further machine learning models. Any number of sets of historical metrology data may be utilized in generating any number of machine learning models, up to a final set, set of historical metrology data 264N (N representing any target quantity of data sets, models, etc.).

In some embodiments, data set generator 272A generates a data set (e.g., training set, validating set, testing set) that includes one or more data inputs 210A (e.g., training input, validating input, testing input) and may include one or more target outputs 220A that correspond to the data inputs 210A. The data set may also include mapping data that maps the data inputs 210A to the target outputs 220A. In some embodiments, data set generator 272A may generate data for training one or more machine learning models configured to output information about defects included in the input image data, e.g., as output defect data 268. In some embodiments, output defect data 268 may be generated by another system for characterizing defects of a substrate, e.g., target output 220A may be output by another model, algorithm, predictive system, etc. Output defect data 268 may be generated by defect classification system 110 of FIG. 1. Data inputs 210A may also be referred to as “features,” “attributes,” or “information.” In some embodiments, data set generator 272A may provide the data set to training engine 182, validating engine 184, or testing engine 186, where the data set is used to train, validate, or test the machine learning model (e.g., synthetic data generator 174, one of the machine learning models that are included in model(s) 190, ensemble model(s) 190, etc.).

FIG. 2B depicts a block diagram of an example data set generator 272B for creating data sets for a supervised model configured to output information about defect properties of a substrate, according to some embodiments. System 200B containing data set generator 272B (e.g., data set generator 172 of FIG. 1) creates data sets for one or more machine learning models (e.g., model(s) 190 of FIG. 1). Data set generator 272B may create data sets (e.g., data input 210B) using historical data.

Example data set generator 272B is configured to generate data sets for a machine learning model configured to take as input image data of a substrate and generate as output matches to historical defects. Analogous data set generators (or analogous operations of data set generator 272B) may be utilized for machine learning models configured to operate on other types of input data, e.g., a machine learning model configured to receive as input metrology image data and generate as output predicted root causes of defects, a machine learning model configured to receive as input image data of a substrate and generate as output recommended corrective actions, a machine learning model configured to receive as input defect classification data (e.g., defect size, defect shape, defect morphology, defect composition) and/or additional data (e.g., device or product type for device being formed on the substrate, process recipe, equipment used to process substrate, etc.) and generate as output matches to historical defects, etc. Data set generator 272B may share features and/or function with data set generator 272A.

Data set generator 272B may generate data sets to train, test, and validate a machine learning model. The machine learning model is provided with set of substrate image data 262A (e.g., image data of one or more portions of a substrate, location data associated with the image data identifying associated substrate locations, etc.) as data input 210B. The machine learning model may include two or more separate models (e.g., the machine learning model may be an ensemble model). The machine learning model may be configured to generate output data including information about one or more matches to historical defect data (e.g., one or more historical defects matching the current substrate defect). In some embodiments, training may not include providing target output to the machine learning model. Data set generator 272B may generate data sets to train an unsupervised machine learning model, e.g., a model configured to generate as output clustering data, outlier detection data, anomaly detection data, etc. Data set generator 272B may generate accompanying target output 220B for the data input 210B. Target output 220B may include output match data 269, e.g., output indicative of one or more matches to historical defects, for configuring a machine learning model to predict matches to historical defects (e.g., defect classification, count, density, location, etc.).

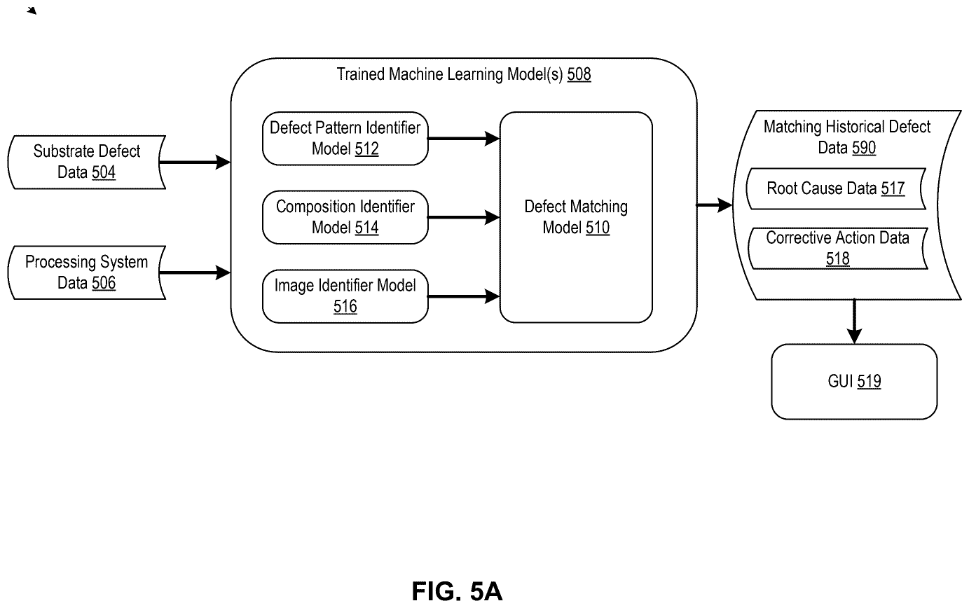

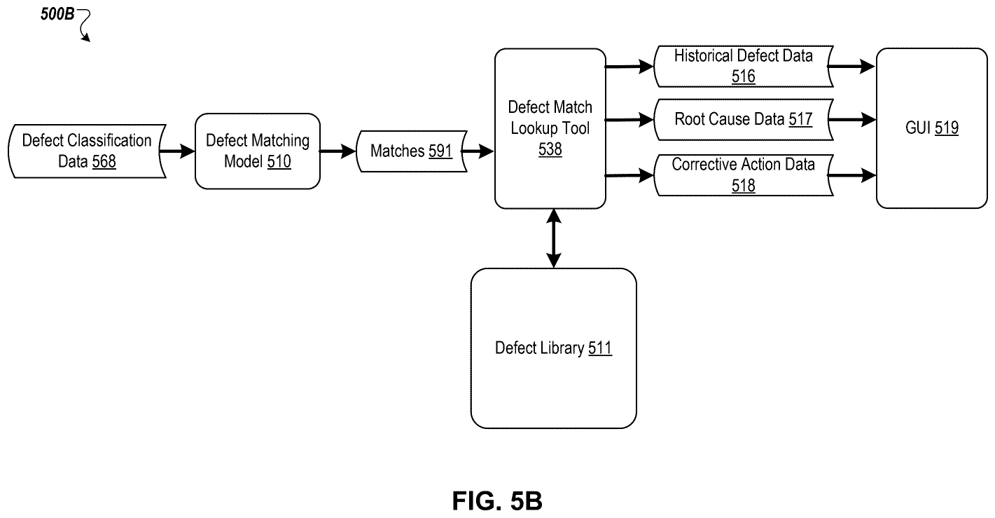

In some embodiments, data set generator 272B generates a data set (e.g., training set, validating set, testing set) that includes one or more data inputs 210B (e.g., training input, validating input, testing input). Data inputs 210B may also be referred to as “features,” “attributes,” or “information.” In some embodiments, data set generator 272B may provide the data set to the training engine 182, validating engine 184, or testing engine 186, where the data set is used to train, validate, or test the machine learning model (e.g., model(s) 190 of FIG. 1). Some embodiments of generating a training set are further described with respect to FIG. 4A.

In some embodiments, data set generator 272B may generate a first data input corresponding to a first set of substrate data 262A to train, validate, or test a first machine learning model and the data set generator 272A may generate a second data input corresponding to a second set of data (e.g., a set of substrate data 262B, not shown) to train, validate, or test a second machine learning model. Further sets of substrate data may further be utilized in generating further machine learning models. Any number of sets of substrate image data may be utilized in generating any number of machine learning models, up to a final set, set of substrate data 262N (N representing any target quantity of data sets, models, etc.).

Data inputs 210B to train, validate, or test a machine learning model may include information for a particular manufacturing chamber (e.g., for particular substrate manufacturing equipment). In some embodiments, data inputs 210B may include information for a specific type of manufacturing equipment, e.g., manufacturing equipment sharing specific characteristics. Data inputs 210B may include data associated with a device of a certain type, e.g., intended function, design, produced with a particular recipe, etc. Training a machine learning model based on a type of equipment, device, recipe, etc. may allow the trained model to generate plausible synthetic sensor data in a number of settings (e.g., for a number of different facilities, products, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

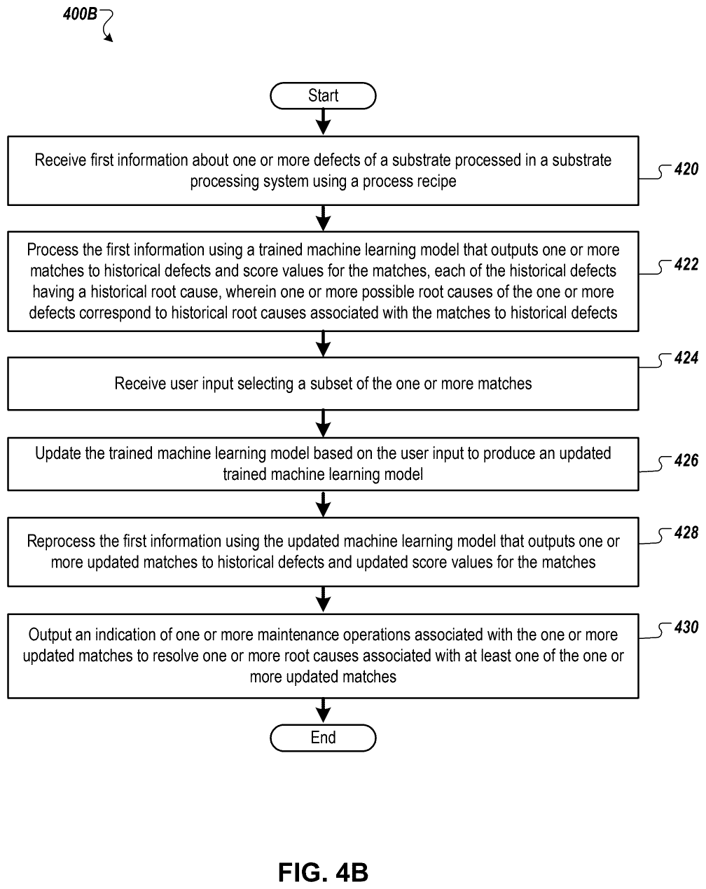

FIG. 3 is a block diagram illustrating system 300 for generating output data (e.g., defect classification data 168 of FIG. 1), according to some embodiments. In some embodiments, system 300 may be used in conjunction with a machine learning model configured to output information about substrate defects (e.g., model(s) 190 of FIG. 1). In some embodiments, system 300 may be used in conjunction with a machine learning model to determine a defect classification data for a defect, or to process defect classification data to determine a match to a historical defect. In some embodiments, system 300 may be used in conjunction with a machine learning model to output matches to historical defects.

At block 310, system 300 (e.g., components of defect classification system 110 of FIG. 1) performs data partitioning (e.g., via data set generator 172 of server machine 170 of FIG. 1) of data to be used in training, validating, and/or testing a machine learning model. In some embodiments, training substrate defect data 364 includes historical data, such as historical metrology data, historical classification data (e.g., classification of defects associated with the same substrates as are represented by the metrology data), historical microscopy image data, etc. In some embodiments, classification data may be provided by a defect classification system, e.g., defect classification system 110 of FIG. 1. Training substrate defect data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. Different models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., an image of a substrate etc.) to generate an output. The output may include, for example, information defects of the substrate (e.g., a characterization of the substrate defects, one or more matches to historical defects, etc.). The output may be compared to a label of the training data item (e.g., information generated by another reliable method).

Processing logic may then compare the generated output (e.g., substrate defect information) to the label (e.g., labeled substrate information) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

At block 314, system 300 performs model validation (e.g., via validation engine 184 of FIG. 1) using the validation set 304. The system 300 may validate each of the trained models using a corresponding set of features of the validation set 304. Responsive to determining that one or more of the trained models has an accuracy that meets a threshold accuracy, flow continues to block 316.

At block 316, system 300 may perform model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Responsive to determining that selected model 308 has an accuracy that meets a threshold accuracy based on testing set 306, flow continues to block 320. In at least block 312, the model may learn patterns in the training data to make classifications. In block 318, the system 300 may apply the model on the remaining data (e.g., testing set 306) to test the classifications.

At block 320, system 300 uses the trained model (e.g., selected model 308) to receive current data 322 and determines (e.g., extracts), from the output of the trained model, defect classification data 324. Current data 322 may be data related to a substrate having a defect in embodiments. Current data 322 may be metrology data of at least a portion of a substrate of interest in some embodiments. Current data 322 may be image data of a substrate of interest. Current data 322 may be textual data of a substrate of interest. A corrective action associated with the manufacturing equipment 124 of FIG. 1 may be performed in view of defect classification data 324. In some embodiments, current data 322 may correspond to the same types of features in the historical data used to train the machine learning model such as metrology data, image data, and/or textual data.

FIGS. 4A-B are flow diagrams of methods 400A-B. FIGS. 4A-B are associated with determining possible root causes of defects of substrates, including defect classification, defect counting, defect predictions, corrective action recommendations based on substrate defects, etc. One or more of FIGS. 4A-B may be associated with training and utilizing machine learning models, according to certain embodiments.

Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-B may be performed, in part, by defect classification system 110.

Methods 400A-B may be performed by defect classification server 112 (e.g., defect classification component 114) and/or server machine 180 (e.g., training, validating, and testing operations may be performed by server machine 180). In some embodiments, a non-transitory machine-readable storage medium stores instructions that when executed by a processing device (e.g., of defect classification system 110, of server machine 180, of defect classification server 112, etc.) cause the processing device to perform one or more of methods 400A-B.

For simplicity of explanation, methods 400A-B are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for determining a possible root cause of a substrate defect. At block 410, processing logic receives first data having a first data type. In some embodiments, the first data is indicative of one or more defects of a substrate processed in a substrate processing system using a process recipe. In some embodiments, the first data is text data (e.g., textual data), spectral data, and/or image data, etc. In some examples, receiving the first data includes receiving one or more images of the substrate. The one or more images may show one or more defects of the substrate. The one or more images of the substrate may be captured by an imaging device, such as a camera. In some examples, receiving the first data includes receiving EDX data of the substrate. The EDX data may include spectral data indicative of the composition of one or more substrate defects. The EDX data may be captured by an EDX imaging or mapping device. In some examples, receiving the first data includes receiving textual data. The textual data may describe one or more features, aspects, characterizations, etc. associated with the substrate and/or the substrate defect(s). The textual data may be input by a user via a GUI and may be based at least in part on user observations.

At block 412, processing logic processes the first data using a first trained machine learning model that outputs first information about the one or more defects (e.g., defect classification data). In some embodiments, processing logic inputs the first data into one or more trained machine learning models. Each of the trained machine learning models may be trained to process different types of input data. For example, one ML model may be trained to process SEM images, another ML model may be trained to process images, another ML model may be trained to process textual data, and so on. In some embodiments, the models are trained for specific product, specific processes and/or specific process chambers or process chamber types. Accordingly, additional information such as a product being manufactured, a process recipe used to process a substrate that experienced a defect, and/or a process chamber that ran the process recipe to process the substrate may be input and used to select an appropriate ML model. Alternatively, such additional information may be input into an ML model, and the additional information may be processed in addition to metrology data to determine the first information about the one or more defects. In some embodiments, a user can provide input via a GUI. The GUI may include multiple input boxes (e.g., text input boxes) for the inputting of textual data. The GUI may include multiple drop-down menus for selection of settings and/or data. The GUI may include at least one feature for uploading data such as data files storing metrology data, etc. In some embodiments, via the GUI, a user can select a product, process, platform (e.g., process chamber, etc.) from drop-down menus. In some embodiments, via the GUI, a user can upload metrology data (e.g., image data) of multiple different types. The metrology data may be indicative of a defect pattern, a defect size, a defect morphology, a defect composition, etc. In some embodiments, a user can select a defect pattern, a defect size, a defect morphology, a defect composition, etc. from drop-down menus.

The trained machine learning model(s) may be trained to output information about the one or more defects. In some embodiments, a first trained machine learning model may be trained to output information about the composition of one or more defects based on input spectral data (e.g., EDX data, etc.). In some embodiments, a second trained machine learning model may be trained to output information about the pattern of one or more substrate defects based on input image data. In some embodiments, a third trained machine learning model may be trained to output information about a match to a historical defect based on input image data. In some embodiments, one or more of the trained machine learning models may be trained to output information about size of the substrate defect(s) based on the input data. In some embodiments, one or more of the ML models is trained to output root causes for the one or more defects. In some embodiments, the one or more trained machine learning models are trained using historical data such as historical substrate defect data, etc.

At block 414, processing logic determines one or more possible root causes for the one or more defects based at least in part on the first information. In some embodiments, processing logic determines the one or more possible root causes based on one or more matches to historical defects. In some embodiments, processing logic processes the outputs generated at block 412 using an additional trained machine learning model. The additional trained ML model may be trained to receive defect classification data and to output matches to one or more historical defects. Information for each of the historical defects may be stored in a data store. The ML model may output a historical defect identifier (ID), which may be used as a key to look up the information for the historical defect from the data store. For example, a data store may store historical defect data and root cause data corresponding and mapped to the historical defect data. Based on a match to a historical defect (e.g., that corresponds to the current substrate defect, etc.), processing logic may identify a corresponding historical root cause. In some embodiments, a historical root cause corresponding to a match to a historical defect may be a possible root cause for the one or more defects indicated in the first data. In some embodiments, the historical root cause information further includes one or more maintenance operations (e.g., a sequency of maintenance operations) that may be performed to confirm or address a possible root cause associated with the matching historical defect, which may or may not also be the root cause for the current defect.

At block 416, processing logic outputs a sequence of maintenance operations to be performed on the substrate processing system based on the one or more possible root causes for the one or more defects. In some examples, the data store referenced above at block 414 may additionally store maintenance operation data corresponding and mapped to the historical root cause data. Based on a match to a historical root case, processing logic may identify one or more corresponding maintenance operations associated with the historical root cause. In some embodiments, maintenance operations associated with a root cause are a subset of a superset of maintenance operations that can be performed with respect to the substrate processing system. The superset of maintenance operations may be a tree of a full maintenance workflow for a process chamber or other processing equipment. However, not all maintenance operations in the workflow may be needed to troubleshoot an identified possible root cause. Accordingly, each root cause may be associated with a subset of the maintenance workflow that may be performed to confirm or reject the possible root cause. The subset of maintenance operations associated with the identified historical root cause may be to resolve one or more root causes associated with the one or more substrate defects. In some embodiments, an indication of the sequence of maintenance operations is output, such as for display on a GUI. Each subset of maintenance operations may indicate an amount of time expected for it to take to complete the sequence of operations, a number of test substrates expected to be used, and/or other information about the sequence of maintenance operations.

FIG. 4B is a flow diagram of a method 400B for determining a possible root cause of a substrate defect. At block 420, processing logic receives first information about one or more defects of a substrate processed in a substrate processing system using a process recipe. In some embodiments, first information includes one or more images (e.g., image data, EDX image data, SEM image data, etc.) showing the one or more defects of the substrate and/or defect classification data. In some embodiments, the defect classification data may have been output by one or more other ML models that may have been used to process various types of metrology data. In some embodiments, first information includes textual information about the one or more defects. The textual data may describe one or more features, aspects, characterizations, etc. associated with the substrate and/or the substrate defect(s). The textual data may be input by a user via a GUI and may be based at least in part on user observations. In some embodiments, first information includes spectral information about the substrate. The spectral information may include information about a composition of the one or more defects. The spectral data may include EDX data indicative of the composition of one or more substrate defects. The spectral data may be captured by a spectroscopy imaging or mapping device. In some embodiments, first information includes one or more images of the substrate. The one or more images may show one or more defects of the substrate. The one or more images may be captured by an imaging device.

At block 422, processing logic processes the first information using a trained machine learning model that outputs one or more matches to historical defects and score values for the matches, each of the historical defects having a historical root cause. For example, and in some embodiments, data indicative of a historical root cause may be stored in a data structure and may be associated with (e.g., mapped to) data indicative of a historical substrate defect. In some embodiments, one or more possible root causes of the one or more defects correspond to historical root causes associated with the matches historical defects. In some embodiments, the trained machine learning model is trained with training data that includes historical substrate defects. The trained machine learning model may be trained to output matches to historical defects that are similar to a substrate defect under consideration. The trained machine learning model may further output a score value for each of the matches. The score value may be indicative of the “closeness” of the match. For example, a score value above a threshold value may indicate a good match, while a score value below a threshold value may indicate a poor match. In some examples, a threshold value may be a score value of 10. A match with a score value of 13 may indicate the match is a good match. A match with a score value of 8 may indicate the match is a poor match. In some embodiments, score values may be expressed as a percentage. For example, a score value may be presented from 0% to 100%. In such an example, a score value above a threshold percentage may indicate a good match while a score value below a threshold percentage may indicate a poor match. In some examples, a threshold percentage may be 70%. A match with a score value of 87% may indicate the match is a good match. A match with a score value of 62% may indicate the match is a poor match.

In some embodiments, processing logic may perform a lookup in a data store for information about matching historical defects. The lookup may be performed based on one or more outputs from the trained machine learning model. For example, the trained machine learning model may output an identifier of a historical defect matching the one or more defects of the substrate. Processing logic may lookup data in the data store corresponding to the identifier. In some embodiments, information about the historical defect(s) may include data associated with the historical defect(s) such as image data, spectral data, textual data, etc. and may further include root cause data. The root cause data may include a root cause associated with the historical defect and/or one or more corrective actions (e.g., corrective action data) for resolving the root cause. In some embodiments, the information about the matching historical defects may be output for viewing (e.g., by a user) on a GUI. For example, and in some embodiments, information such as an image, etc. of the one or more matches to historical defects are presented on a GUI.

At block 424, processing logic may receive user input selecting a subset of the one or more matches to historical defects. In some embodiments, the one or more matches to historical defects are presented for viewing by the user on a GUI. The user may select one or more matches that most closely match the one or more substrate defects. The one or more matches may be selected based on the user's prior experience and may reflect historical defects that the user believes are likely to be the same as the current defect. The one or more matches that are not selected may correspond to matches that the user knows are not the same as the current defect, for example.

At block 426, processing logic may update the trained machine learning model based on the user input to produce an updated trained machine learning model. In some embodiments, the user input is input into the trained machine learning model as training data. The trained machine learning model may be further trained based on the user input to produce the updated trained machine learning model. The user input may be used to adjust weights connecting one or more nodes of the ML model, for example.

At block 428, processing logic may reprocess the first information using the updated trained machine learning model, that may output one or more updated matches to historical defects and updated score values for the matches. In some embodiments, the updated trained machine learning model utilizes the updates from the user input to output the one or more updated matches. For example, the updated trained machine learning model outputs updated matches based on the user input indicating a subset of matches that more closely resemble the one or more substrate defects. In some embodiments, the updated trained machine learning model utilizes the updates from the user input to output the one or more updated score values. For example, the updated trained machine learning model outputs updates score values based on the user input indicating a subset of matches more closely resemble the one or more substrate defects.

At block 430, processing logic outputs an indication of one or more root causes and one or more maintenance operations associated with the one or more updated matches to resolve the one or more root causes associated with at least one of the one or more updated matches. In some embodiments, a data structure storing data indicative of the one or more updated matches stores data indicative of historical root causes corresponding to each of the matches to historical defects. In some embodiments, the data structure further stores data indicative of maintenance operations associated with the historical root causes. In some embodiments, processing logic identifies from the data structure the maintenance operations for the one or more updated matches. The maintenance operations may be a subset of a superset of maintenance operations with respect to the substrate processing system. In some embodiments, the one or more maintenance operations can be performed with respect to the substrate processing system to resolve one or more root causes associated with the one or more updated matches. Performance of the maintenance operations may resolve a root cause of the one or more defects of the substrate. In some embodiments, an indication of the one or more maintenance operations is output, such as for display on a GUI.

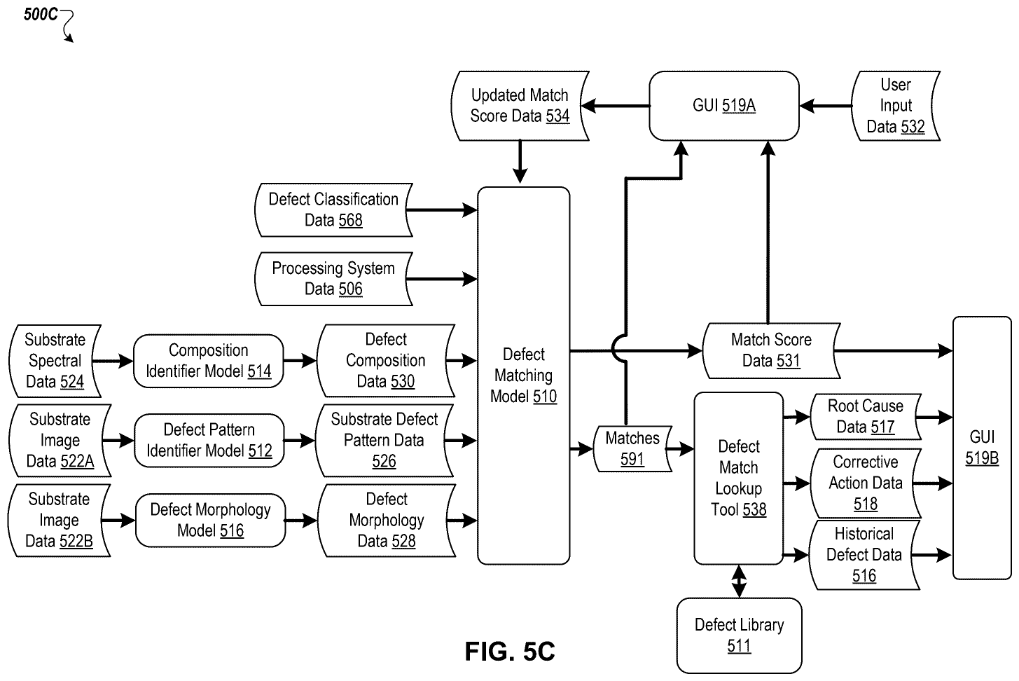

FIG. 5A-C are block diagrams of flows for determining a possible root cause of a substrate defect, according to some embodiments. Referring to FIG. 5A, a block diagram 500A is shown. In some embodiments, substrate defect data 504 and processing system data 506 are input into one or more trained machine learning model(s) 508. Substrate defect data 504 may be data indicative of one or more defects of a substrate processed in a substrate processing system. For example, substrate defect data 504 may include image data (e.g., one or more images of substrates, one or more images of substrate defects, etc.), spectral data (e.g., indicative of substrate composition and/or indicative of substrate defect composition), and/or textual data describing the one or more defects. In some embodiments, substrate defect data 504 may include one or more data types. For example, substrate defect data 504 may include a first data type (e.g., image data), a second data type (e.g., spectral data), and/or a third data type (e.g., textual data), etc. Substrate defect data 504 may correspond to current defect data 166 described herein with respect to FIG. 1. In some embodiments, processing system data 506 includes data associated with the substrate processing system, such as equipment settings data, equipment parameter data, equipment age or run time data, an identify of equipment (e.g., of a process chamber) used to process the substrate, etc. Processing system data 506 may further include process recipe data. In some embodiments, processing system data 506 includes configuration data (e.g., processing system configuration data, etc.), and/or an identity of a process recipe. At least a portion of processing system data 506 may correspond to manufacturing parameters 150 described herein with respect to FIG. 1.

In some embodiments, trained machine learning model(s) 508 includes multiple machine learning models. Trained machine learning model(s) 508 may include a defect pattern identifier model 512, a composition identifier model 514, an defect morphology model 516, and/or a defect matching model 510 defect matching model 510. At least one of the machine learning models may be configured to process a different type of data. For example, the composition identifier model 514 may be configured to process spectral data while both the defect pattern identifier model 512 and the defect morphology model 516 may be configured to process image data such as conventional image data (e.g., captured by a camera, etc.) and/or SEM image data (e.g., captured by a scanning electron microscope, etc.). The defect matching model 510 may be configured to process textual data. In some embodiments, each of the defect pattern identifier model 512, the composition identifier model 514, and/or the defect morphology model 516 output textual data. The textual data may be input into the defect matching model 510. Textual data included in the substrate defect data 504 and/or the processing system data 506 may be input directly into the defect matching model 510.

Each of the defect pattern identifier model 512, the composition identifier model 514, and/or the defect morphology model 516 may process different data types to generate textual data as output. In some embodiments, the defect pattern identifier model 512 receives image data as input. The defect pattern identifier model 512 may process the image data to generate a textual data output indicative of a defect pattern (e.g., a pattern of defect(s) of a processed substrate). In some embodiments, the composition identifier model 514 receives spectral data as input. The composition identifier model 514 may process the spectral data to generate a textual data output indicative of a composition of one or more defects and/or a composition of a processed substrate. In some embodiments, the defect morphology model 516 receives image data as input. The defect morphology model 516 may process the image data to generate a textual data output indicative of the identification of one or more defects (e.g., identification of a type of defect, etc.) of a processed substrate. The textual data output from each of the defect pattern identifier model 512, the composition identifier model 514, and/or the defect morphology model 516 may be provided as input to the defect matching model 510. In some embodiments, the text-based model receives the textual data as input. In some embodiments, the text-based model receives the substrate defect data 504 and/or the processing system data 506 directly as textual input data. The defect matching model 510 may process the textual data to generate output data indicative of one or more matching historical defects.

In some embodiments, the one or more trained machine learning model(s) 508 output information about the one or more substrate defects. For example, and in some embodiments, the trained machine learning model(s) 508 output matching historical defect data 590. Matching historical defect data 590 may be data indicative of one or more matches to historical defects corresponding to the substrate defects indicated in substrate defect data 504. In some embodiments, matching historical defect data 590 includes root cause data 571 and/or corrective action data 518. Alternatively, the matching historical defect data 590 may include identifies to one or more matching historical defects, which may be used to perform a lookup in a data store to retrieve the root cause data 517 and/or corrective action data 518. The root cause data 517 may include data indicative of one or more root causes of historical substrate defects. The root causes may be possible root causes for the substrate defect(s) indicated in the substrate defect data 504. The corrective action data 518 may include data indicative of one or more corrective actions associated with the one or more root causes. The one or more corrective actions may include a sequence of maintenance operations that can be performed on the substrate processing system to resolve the root causes associated with the historical defect(s). In some embodiments, the matching historical defect data 590 is output for display on a GUI 519. A user may view the GUI 519 to view the possible root cause(s) indicated by the root cause data 517 and/or the corrective action(s) indicated by the corrective action data 518.

Referring to FIG. 5B, a block diagram 500B is shown. In some embodiments, defect classification data 568 is input into the defect matching model 510. Defect classification data 568 may be indicative of one or more substrate defects. In some embodiments, defect classification data 568 may include text information describing the one or more substrate defects. For example, and in some embodiments, defect classification data 568 may include text information describing the defect composition, text information describing the substrate defect pattern, text information describing images matching the defect, and/or text information describing one or more other characteristics of the substrate defect(s). In some embodiments, defect classification data includes image data showing defects. Defect classification data 568 may correspond to defect classification data 168 described herein above with respect to FIG. 1.

In some embodiments, the defect matching model 510 receives the defect classification data 568 as input and outputs information about one or more substrate defects. In some embodiments, the defect matching model 510 outputs matches 591. Matches 591 may be matches to historical defects (e.g., information about matches to historical defects, etc.). Matches to historical defects may include associated match scores indicating how similar a current defect is to an indicated historical defect. The information may be output to a defect match lookup tool 538. In some embodiments, the defect match lookup tool 538 uses the matches 591 to query a defect library 511. In some embodiments, the defect library 511 is a data store (e.g., a database, a data structure, etc.) containing data indicative of multiple historical defects, including historical root cause information, metrology data, engineer and/or technician notes and/or corrective action information (e.g., steps that were taken to identify and/or correct a root cause of the historical defect) for each of the historical defects. Data stored in the defect library 511 may correspond to historical defect data 164 described herein with respect to FIG. 1.

In some embodiments, the defect match lookup tool 538 may search the defect library 511 for historical match information corresponding to matches 591. In some embodiments, the defect match lookup tool 538 retrieves root cause data 517 and/or corrective action data 518 from the defect library 511. In some embodiments, the defect library 511 stores corrective action information associated with each of the historical defects. Alternatively, defect match lookup tool 538 may receive root cause data 517 from the defect library 511 and may determine corrective action data 518 based on the root cause data 518 (e.g., by performing a lookup into defect library 511 or into a corrective action library). In one embodiment, the corrective action information stored in the defect library 511 may be mapped to a corresponding historical defect. The root cause data 517 may be indicative of one or more root causes of the one or more matches 591. In some embodiments, the root cause data 517 is indicative of one or more possible root causes of the substrate defects indicated in the defect classification data 568. In some embodiments, the corrective action data 518 is indicative of one or more maintenance operations (e.g., a subset of maintenance operations) from a tree of maintenance operations (e.g., a superset of maintenance operations). The tree of maintenance operations may be for the substrate processing system. The one or more maintenance operations indicated by the corrective action data 518 may be to resolve one or more root causes indicated in the root cause data 517. In some embodiments, the root cause data 517 and/or the corrective action data 518 are prepared for display on a GUI 519. Additionally, historical defect data 516 about the matching historical defects may be output to GUI 519. The historical defect data 516 may include historical metrology data, troubleshooting steps taken, image data, and so on.

Referring to FIG. 5C, a block diagram 500C is shown. In some embodiments, as described herein above, defect classification data 568 is input into a defect matching model 510. Defect classification data 568 may be text data describing one or more characteristics of one or more defects of a substrate. The text data may have been input by an engineer or technician, for example. The text data may include, for example, engineer observations about a defect, such as a defect location, shape, size, and so on. In some embodiments, as described herein above, processing system data 506 is input into defect matching model 510. Processing system data 506 may be text data describing one or more characteristics, parameters, recipes, etc. associated with a substrate processing system used to process the substrate. Processing system data 506 may include, for example, a process chamber type that processed a substrate for which a defect was found, a specific process chamber of the process chamber type, type of product associated with the substrate, a process recipe run on the process chamber for the substrate, and so on. In some embodiments, defect classification data 568 and/or processing system data 506 have a data type that can be input directly into defect matching model 510. For example, as described herein, defect classification data 568 and/or processing system data 506 may have a textual data type that can be input directly into defect matching model 510. In some embodiments, defect classification data 568 and/or processing system data 506 can be input to the defect matching model 510 by a user via a GUI.

In some embodiments, substrate spectral data 524 and/or substrate image data 522 have one or more data types that cannot be input directly into defect matching model 510. For example, defect matching model 510 may be configured to receive a textual data type while substrate spectral data 524 may have a spectral data type and substrate image data 522 may have an image data type. The substrate spectral data 524 and/or the substrate image data 522 may be processed by one or more trained machine learning models that output data having a textual data type (e.g., that can be input into the defect matching model 510). In some embodiments, substrate spectral data 524 and/or substrate image data 522 are included in metrology data 160 described herein above with respect to FIG. 1.

In some embodiments, substrate spectral data 524 is input into the composition identifier model 514. Spectral data 524 may have a data type different from defect classification data 568. For example, and in some embodiments, substrate spectral data 524 may be indicative of a spectrum analysis of the substrate and/or the substrate defect(s). In some embodiments, the composition identifier model 514 is a trained machine learning model that outputs information about one or more substrate defects. In some embodiments, the composition identifier model 514 outputs information about the composition of one or more substrate defects. For example, and in some embodiments, the composition identifier model 514 outputs defect composition data 530 indicative of the composition of one or more substrate defects. The composition may indicate which materials or elements are included in the defect (e.g., oxygen, silicon, fluorine, and so on) and/or an amount of the different materials or elements. In some embodiments, the defect composition data 530 has a textual data type that can be input into the defect matching model 510.

In some embodiments, substrate image data 522A-B is input into a defect pattern identifier model 512 and/or an defect morphology model 516. In some embodiments, image data 522A is input into defect pattern identifier model 512 and substrate image data 522B is input into defect morphology model 516. Image data 522A may be indicative of one or more images of a substrate and/or of a substrate defect. Image data 522B may be indicative of an SEM image of a substrate and/or of a substrate defect. Substrate image data 522A-B may have a data type different from defect classification data 568 and/or substrate spectral data 524. In some embodiments, substrate image data 522A-B may include image data and/or map data as generated by a metrology device. For example, and in some embodiments, substrate image data 522 may be indicative of one or more images of the substrate and/or defect(s) of the substrate. In another example, and in some embodiments, substrate image data 522 may be indicative of one or more maps (e.g., a surface profile map) of the substrate and/or defect(s) of the substrate. In some embodiments, the defect pattern identifier model 512 is a trained machine learning model that outputs information about one or more substrate defects. In some embodiments, the defect pattern identifier model 512 outputs information about the pattern of the substrate defects. For example, and in some embodiments, the defect pattern identifier model 512 outputs substrate defect pattern data 526. The substrate defect pattern data 526 may be indicative of a pattern of the substrate defect(s). For example, and in some embodiments, substrate defect pattern data 526 may indicative that the substrate defects have a random pattern, an edge pattern, a spray pattern, a starburst pattern, etc. In some embodiments, the substrate defect pattern data 526 may be indicative of the location of the substrate defect(s) and/or the location of the substrate defect pattern. In some embodiments, the substrate defect pattern data 526 has a textual data type that can be input into the defect matching model 510.

In some embodiments, the defect morphology model 516 is a trained machine learning model that outputs information about one or more substrate defects. In some embodiments, the defect morphology model 516 outputs information about the morphology of the substrate defect(s). For example, and in some embodiments, the defect morphology model 516 outputs defect morphology data 528. The defect morphology data 528 may be indicative of the morphology of the substrate defect(s). For example, the defect morphology data 528 may include data identifying the structure, form, and/or size of a substrate defect. In another example, the defect morphology data 528 may be indicative of a shape or a profile of the defect. In a further example, the defect morphology data 528 may be indicative of how the substrate defect(s) looks. In some embodiments, the defect morphology data 528 has a textual data type that can be input into the defect matching model 510.

In some embodiments, the defect classification data 568, the processing system data 506, the defect composition data 530, the substrate defect pattern data 526, and/or the defect morphology data 528 is input into the defect matching model 510. In some embodiments, the defect matching model 510 is a trained machine learning model that outputs information about one or more substrate defects. For example, the defect matching model 510 may output matches 591 to historical defects. The matches 591 may be input into the defect match lookup tool 538 as described herein above.

In some embodiments, the defect matching model 510 outputs match score data 531. Match score data 531 may be indicative of one or more score values associated with each of the matches output by the defect matching model 510. The one or more score values may indicate a similarity between the information about the substrate defect and corresponding information of one or more historical defects (e.g., identified by the defect match lookup tool 538 from the defect library 511). In some embodiments, the defect matching model 510 includes one or more trained machine learning models. In some embodiments, the defect matching model 510 includes a first portion to output information about the substrate defects and a second portion to output the match score data 531. Defect match lookup tool 538 may use historical defect identifiers output by defect matching model 510 (e.g., each being associated with a different match to a historical defect) to perform a lookup in the defect library 511 to obtain information about a historical defect. The retrieved information may include a root cause associated with the historical defect, one or more actions to perform (e.g., a sequence of maintenance actions) to diagnose the possible root cause, historical image data, and so on. In some embodiments, the match score data 531, the root cause data 517, historical defect data 516 (e.g., including image data of the historical defects) and/or the corrective action data 518 are output for display on a GUI 519B.

In some embodiments, the matches 591 are displayed on a GUI 519A for viewing by a user (e.g., images indicative of the matches 591 are displayed on the GUI 519A). In some embodiments, the matches 591 are displayed in a ranked order based on the match score data 531. For example, a match having a highest score may be displayed in a first position in the order while a match having a lowest score may be displayed in a last position in the order, etc. In some embodiments, the scores are indicative of how closely each of the matches 591 correspond to the current substrate and/or current substrate defect. Ranking of the matches 591 may be based on the match score data 531 and display of the matches 591 on the GUI 519A may be based on the ranking.

In some embodiments, the user provides user input (e.g., via the GUI 519A) to select one or more of the matches that at least partially match the current substrate and/or the current substrate defects. For example, the user may select an image of a match 591 that matches an image of the current substrate and/or the current substrate defect. The user may select multiple images indicative of one or more of the matches 591. In some embodiments, the user may rank the matches 591. For example, the user may assign a match that the user perceives as most closely matching the current substrate and/or the current substrate defect a first ranking, and the user may assign a match that the user perceives as least closely matching the current substrate and/or the current substrate defect a last ranking, etc. Based on the ranking by the user and/or selected and/or unselected matches by the user, updated match score data 534 may be generated. For example, the score value for the match 591 that the user ranked first may be increased, while the score value for the match 591 that the user ranked last may be decreased. The updated match score data 534 may be indicative of the score values for the ranked matches 591.

In some embodiments, the updated match score data 534 is provided as training input to the defect matching model 510. The updated match score data 534 may be provided to the defect matching model 510 to update the model. Once the defect matching model 510 is updated, the defect matching model 510 may reprocess the defect classification data 568, the processing system data 506, the defect composition data 530, the substrate defect pattern data 526, and/or the defect morphology data 528 and may output updated matches 591 and/or match score data 531 (e.g., updated match score data). The updated matches 591 may be provided to the defect match lookup tool 538 which may retrieve updated root cause data 517 and/or updated corrective action data 518 from the defect library 511. The updated root cause data 517 and/or the updated corrective action data 518 may be output for display on the GUI 519B.

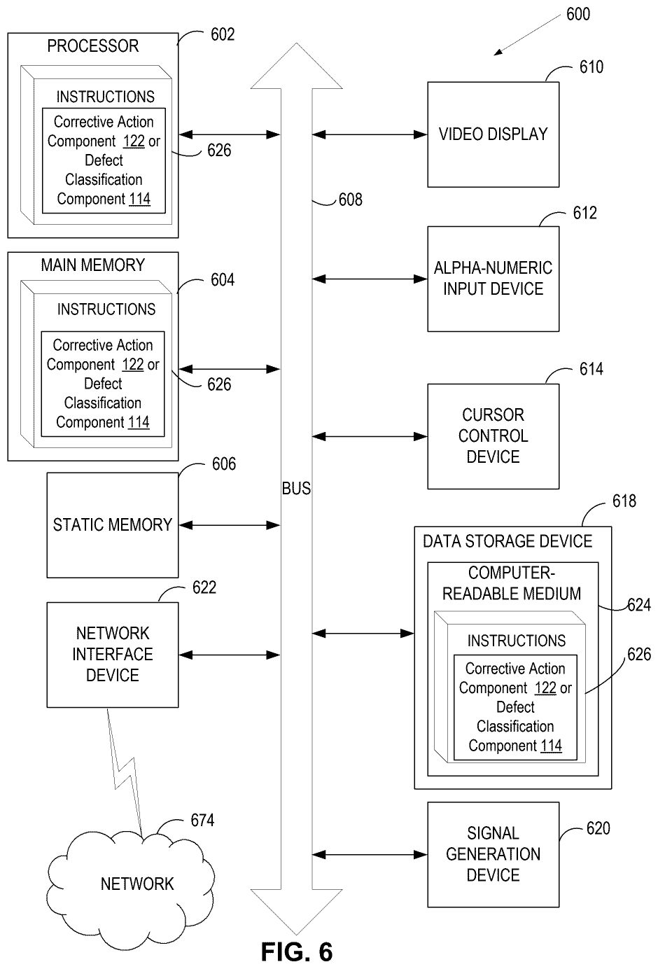

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable 624 (e.g., non-transitory machine-readable storage medium storing instructions) on which may store instructions 626 encoding any one or more of the methods or functions described herein, including instructions encoding components of FIG. 1 (e.g., defect classification component 114, corrective action component 122, model(s) 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While non-transitory computer-readable medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” “outputting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
receiving, by a processing device, first information about one or more defects of a substrate processed in a substrate processing system using a process recipe;
processing, by the processing device, the first information using a trained machine learning model that outputs one or more matches to historical defects and score values for the matches, each of the historical defects having a historical root cause, wherein one or more possible root causes of the one or more defects correspond to historical root causes associated with the matches to historical defects;
receiving, by the processing device, user input selecting a subset of the one or more matches;
updating, by the processing device, the trained machine learning model based on the user input to produce an updated trained machine learning model;
reprocessing, by the processing device, the first information using the updated trained machine learning model that outputs one or more updated matches to historical defects and updated score values for the matches; and
outputting, by the processing device, an indication of one or more maintenance operations associated with the one or more updated matches to resolve one or more root causes associated with at least one of the one or more updated matches.

2. The method of claim 1, further comprising:
retrieving, by the processing device, from a data structure, second information associated with the one or more matches to historical defects, wherein retrieving of the second information is based on the first information, and wherein the second information is indicative of the one or more maintenance operations.

3. The method of claim 1, wherein updating the trained machine learning model based on the user input comprises:
providing, by the processing device, the user input to the trained machine learning model as training data, wherein the trained machine learning model is further trained based on the user input.

4. The method of claim 1, wherein the trained machine learning model comprises:
a first portion to output the one or more matches to historical defects based on the first information; and
a second portion to assign the score values, based at least in part on the user input, for the one or more matches to historical defects.

5. The method of claim 1, further comprising:
ranking, by the processing device, the one or more matches to historical defects based on the score values for the matches; and
providing, by the processing device, information associated with the one or more matches to historical defects for display on a graphical user interface (GUI) in a ranked order based on the ranking.

6. The method of claim 5, wherein the user input comprises a ranking of one or more images associated with the matches to historical defects, and wherein the score values are determined based at least in part on the ranking.

7. The method of claim 1, wherein the first information comprises one or more images of the one or more defects of the substrate processed in the substrate processing system, and wherein the trained machine learning model outputs one or more images of the historical defects.

8. A system, comprising memory and a processing device coupled to the memory, wherein the processing device is configured to:
receive first information about one or more defects of a substrate processed in a substrate processing system using a process recipe;
process the first information using a trained machine learning model that outputs one or more matches to historical defects and score values for the matches, each of the historical defects having a historical root cause, wherein one or more possible root causes of the one or more defects correspond to historical root causes associated with the matches to historical defects;
receive user input selecting a subset of the one or more matches;
update the trained machine learning model based on the user input to produce an updated trained machine learning model;
reprocess the first information using the updated trained machine learning model that outputs one or more updated matches to historical defects and updated score values for the matches; and
output an indication of one or more maintenance operations associated with the one or more updated matches to resolve one or more root causes associated with at least one of the one or more updated matches.

9. The system of claim 8, wherein the processing device is further configured to:
retrieve, from a data structure, second information associated with the one or more matches to historical defects, wherein retrieving of the second information is based on the first information, and wherein the second information is indicative of the one or more maintenance operations.

10. The system of claim 8, wherein to update the trained machine learning, the processing device is configured to:
provide the user input to the trained machine learning model as training data, wherein the trained machine learning model is further trained based on the user input.

11. The system of claim 8, wherein the trained machine learning model comprises:
a first portion to output the one or more matches to historical defects based on the first information; and
a second portion to assign the score values, based at least in part on the user input, for the one or more matches to historical defects.

12. The system of claim 8, wherein the processing device is further configured to:
rank the one or more matches to historical defects based on the score values for the matches; and
provide information associated with the one or more matches to historical defects for display on a graphical user interface (GUI) in a ranked order based on the ranking.

13. The system of claim 12, wherein the user input comprises a ranking of one or more images associated with the matches to historical defects, and wherein the score values are determined based at least in part on the ranking.

14. The system of claim 8, wherein the first information comprises one or more images of the one or more defects of the substrate processed in the substrate processing system, and wherein the trained machine learning model outputs one or more images of the historical defects.

15. A non-transitory machine-readable storage medium storing instructions which, when executed, cause a processing device to perform operations comprising:
receiving first information about one or more defects of a substrate processed in a substrate processing system using a process recipe;
processing the first information using a trained machine learning model that outputs one or more matches to historical defects and score values for the matches, each of the historical defects having a historical root cause, wherein one or more possible root causes of the one or more defects correspond to historical root causes associated with the matches to historical defects;
receiving user input selecting a subset of the one or more matches;
updating the trained machine learning model based on the user input to produce an updated trained machine learning model;
reprocessing the first information using the updated trained machine learning model that outputs one or more updated matches to historical defects and updated score values for the matches; and
outputting an indication of one or more maintenance operations associated with the one or more updated matches to resolve one or more root causes associated with at least one of the one or more updated matches.

16. The non-transitory machine-readable storage medium of claim 15, wherein the processing device is to perform operations comprising:
retrieving, from a data structure, second information associated with the one or more matches to historical defects, wherein retrieving of the second information is based on the first information, and wherein the second information is indicative of the one or more maintenance operations.

17. The non-transitory machine-readable storage medium of claim 15, wherein updating the trained machine learning model based on the user input comprises:
providing the user input to the trained machine learning model as training data, wherein the trained machine learning model is further trained based on the user input.

18. The non-transitory machine-readable storage medium of claim 15, wherein the trained machine learning model comprises:
a first portion to output the one or more matches to historical defects based on the first information; and
a second portion to assign the score values, based at least in part on the user input, for the one or more matches to historical defects.

19. The non-transitory machine-readable storage medium of claim 15, wherein the processing device is to perform operations further comprising:
ranking the one or more matches to historical defects based on the score values for the matches; and
providing information associated with the one or more matches to historical defects for display on a graphical user interface (GUI) in a ranked order based on the ranking, wherein the user input comprises a ranking of one or more images associated with the matches to historical defects, and wherein the score values are determined based at least in part on the ranking.

20. The non-transitory machine-readable storage medium of claim 19, wherein the user input comprises a ranking of one or more images associated with the matches to historical defects, and wherein the score values are determined based at least in part on the ranking.
